(19) United States
(12) Patent Application Publication
(10) Pub. No.: US 2026/0219608 A1
(43) Pub. Date: Jul. 30, 2026

(54) FIXING DEVICE, IMAGE FORMING APPARATUS, AND TEMPERATURE SENSOR CAPABLE OF SUPPRESSING COMPRESSION OF SHEET CONVEYING SPACE AND INCREASING FLEXIBILITY OF CABLE ROUTING

(71) Applicant: KYOCERA Document Solutions Inc., Osaka (JP)

(72) Inventor: Yuichi Sugiyama, Osaka (JP)

(21) Appl. No.: 19/444,767

(22) Filed: Jan. 9, 2026

(30) Foreign Application Priority Data
Jan. 30, 2025 (JP) 2025-013728

(51) Int. Cl. G03G 15/20

(52) U.S. Cl. CPC G03G 15/2039; G03G 15/2064; G03G 2215/2035

(57) ABSTRACT

A fixing device includes a temperature sensor that is provided on a support surface facing a fixing member and detects a temperature of the fixing member. The temperature sensor includes a substrate, a connector, a temperature detection device, and a pair of through hole portions. The connector is provided at an end of the substrate on a downstream side in a first direction along one side of the substrate and has a connection portion to which a cable is connected that faces the first direction. The temperature detection device is provided upstream of the connector on the substrate in the first direction and detects the temperature of the fixing member. The pair of through hole portions is provided on both sides of the temperature detection device in a second direction orthogonal to the first direction and used for positioning the temperature sensor on the support surface.

### INCORPORATION BY REFERENCE

This application is based upon and claims the benefit of priority from the corresponding Japanese Patent Application No. 2025-013728 filed on January 30, 2025, the entire contents of which are incorporated herein by reference.

### BACKGROUND

The present disclosure relates to a fixing device, an image forming apparatus, and a temperature sensor.

A sheet conveying device is known that includes a displacement detection sensor, the displacement detection sensor being provided to face a detection roller and detecting the amount of displacement of the detection roller, the detection roller being displaceable in accordance with the thickness of a sheet passing between the detection roller and a reference roller.

Further, an image forming apparatus is known that includes a fixing device for fixing the toner image transferred onto the sheet to the sheet. For example, the fixing device includes a fixing member, a pressure member, a heater, a support surface forming portion, and a temperature sensor. The fixing member is provided to be rotatable and fixes the toner image transferred onto the sheet to the sheet. The pressure member forms a fixing nip portion between the pressure member and the fixing member. The heater is provided to face the pressure member with the fixing member sandwiched therebetween, and heats the fixing member. The support surface forming portion is provided separately from the pressure member and the heater and forms a support surface facing the fixing member. The temperature sensor is provided on the support surface and detects the temperature of the fixing member. The temperature sensor includes a temperature detection device, a connector into which a cable is inserted, a substrate on which the temperature detection device and the connector are mounted, and a pair of through hole portions for positioning, which is formed on the substrate.

If the width of the support surface along the outer periphery of the fixing member is large, the conveying space for the sheet conveyed via the fixing nip portion is compressed by the support surface forming portion. For this reason, it is desirable to make the width of the support surface as narrow as possible. Meanwhile, a fixing device is known in the related art, including the temperature sensor in which the connector, the temperature detection device, and the pair of through hole portions are arranged in a row along the longitudinal direction of the substrate that is long in one direction, the temperature sensor being disposed on the support surface in the posture along the rotation axis of the fixing member.

### SUMMARY

A fixing device according to an aspect of the present disclosure includes: a fixing member; a pressure member; a heater; a support surface forming portion; and a temperature sensor. The fixing member is mounted to be rotatable and fixes a toner image transferred onto a sheet to the sheet. The pressure member forms a fixing nip portion between the pressure member and the fixing member. The heater is provided to face the pressure member with the fixing member sandwiched therebetween and heats the fixing member. The support surface forming portion is provided separately from the pressure member and the heater and forms a support surface facing the fixing member. The temperature sensor is provided on the support surface and detects a temperature of the fixing member. Further, the temperature sensor includes a substrate, a connector, a temperature detection device, and a pair of through hole portions. The substrate is formed in a rectangular shape. The connector is provided at an end of the substrate on a downstream side in a first direction along one side of the substrate and has a connection portion to which a cable is connected that faces the first direction. The temperature detection device is provided upstream of the connector on the substrate in the first direction and detects the temperature of the fixing member. The pair of through hole portions is provided on both sides of the temperature detection device in a second direction orthogonal to the first direction and used for positioning the temperature sensor on the support surface.

An image forming apparatus according to another aspect of the present disclosure includes: the fixing device, the fixing device being used to form an image on the sheet.

A temperature sensor according to another aspect of the present disclosure is provided on a support surface in a fixing device that includes a fixing member that is mounted to be rotatable and fixes a toner image transferred onto a sheet to the sheet, a pressure member that forms a fixing nip portion between the pressure member and the fixing member, a heater that is provided to face the pressure member with the fixing member sandwiched therebetween and heats the fixing member, and a support surface forming portion that is provided separately from the pressure member and the heater and forms the support surface facing the fixing member, and detects a temperature of the fixing member, including: a substrate, a connector, a temperature detection device, and a pair of through hole portions. The substrate is formed in a rectangular shape. The connector is provided at an end of the substrate on a downstream side in a first direction along one side of the substrate and has a connection portion to which a cable is connected that faces the first direction. The temperature detection device is provided upstream of the connector on the substrate in the first direction and detects the temperature of the fixing member. The pair of through hole portions is provided on both sides of the temperature detection device in a second direction orthogonal to the first direction and used for positioning the temperature sensor on the support surface.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF FIGURES

FIG. 1 is a cross-sectional view showing a configuration of an image forming apparatus according to an embodiment.

FIG. 2 is a cross-sectional view showing a configuration of a fixing device in the image forming apparatus according to the embodiment.

FIG. 3 is a plan view showing a configuration of a support surface forming portion and a temperature sensor in the image forming apparatus according to the embodiment.

FIG. 4 is a plan view showing a configuration of a support surface forming portion and a temperature sensor in an existing image forming apparatus.

FIG. 5 is a plan view showing a configuration of a support surface forming portion and a temperature sensor in an image forming apparatus according to another embodiment.

### DETAILED DESCRIPTION

Embodiments of the present disclosure will be described below with reference to the drawings. Note that the following embodiments are merely examples embodying the present disclosure and do not limit the technical scope of the present disclosure.

### Configuration of image forming apparatus 10

An image forming apparatus 10 according to an embodiment executes print processing using an electrophotographic method. The print processing is processing of forming an image on a sheet SH.

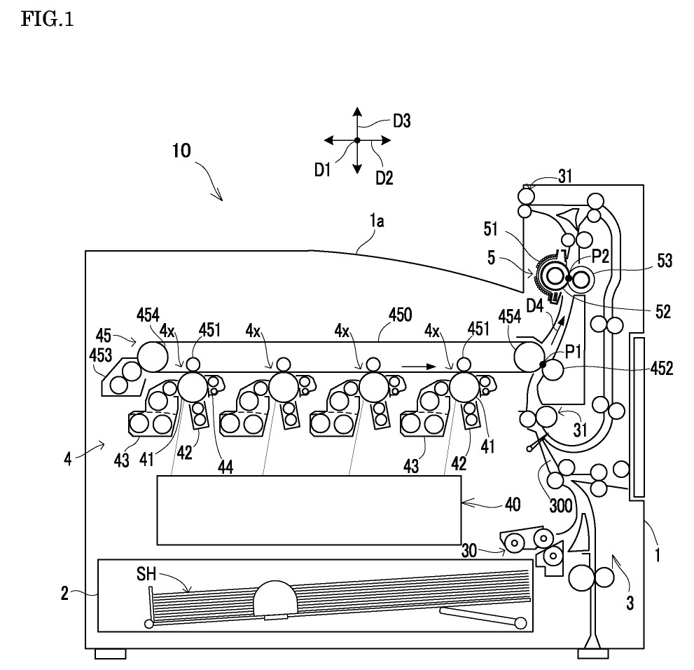

As shown in FIG. 1, the image forming apparatus 10 includes a sheet housing portion 2, a sheet conveying device 3, and a print device 4. The sheet conveying device 3 and the print device 4 are housed in a body portion 1 (see FIG. 1) that is a housing.

Note that for convenience of description, the vertical direction in the installed state where the image forming apparatus 10 can be used (state shown in FIG. 1) is defined as an up-and-down direction D3. Further, a front-and-rear direction D1 is defined with the surface of the image forming apparatus 10 shown in FIG. 1 on the front side of the page as the front surface (front). Further, a right-and-left direction D2 is defined with reference to the front surface of the image forming apparatus 10 in the installed state.

The sheet housing portion 2 is capable of housing a plurality of sheets SH.

The sheet conveying device 3 includes a sheet feeding device 30 and a plurality of sets of conveying roller pairs 31.

The sheet feeding device 30 feeds the sheet SH housed in the sheet housing portion 2 to a conveying path 300 one at one time. The conveying path 300 is a passage for the sheet SH.

The plurality of sets of conveying roller pairs 31 conveys the sheet SH along the conveying path 300. One of the plurality of sets of conveying roller pairs 31 outputs the sheet SH on which an image has been formed onto an output tray 1a (see FIG. 1) from the conveying path 300.

The print device 4 executes the print processing on the sheet SH conveyed along the conveying path 300. The image to be formed on the sheet SH is a toner image.

The print device 4 includes an optical scanning unit 40, one or more image forming units 4x, a transfer device 45, and a fixing device 5.

The image forming unit 4x includes a photoreceptor 41, a charging device 42, a development device 43, and a drum cleaning device 44.

The charging device 42 charges the surface of the photoreceptor 41. The optical scanning unit 40 scans a beam of light across the charged surface of the photoreceptor 41. In this way, the optical scanning unit 40 forms an electrostatic latent image on the surface of the photoreceptor 41.

The development device 43 supplies a toner to the surface of the photoreceptor 41 to develop the electrostatic latent image into a toner image. The transfer device 45 transfers the toner image formed on the surface of the photoreceptor 41 to the sheet SH.

The transfer device 45 transfers the toner image to the sheet SH at a transfer position P1 (see FIG. 1) in the conveying path 300.

In this embodiment, the print device 4 is a tandem-type color printing device including a plurality of image forming units 4x. Further, the transfer device 45 includes an intermediate transfer belt 450, a plurality of primary transfer devices 451, a secondary transfer device 452, and a belt cleaning device 453.

In the example shown in FIG. 1, the print device 4 includes four image forming units 4x corresponding to toners of colors, i.e., yellow, magenta, cyan, and black. The transfer device 45 includes four primary transfer devices 451 corresponding to the four image forming units 4x.

The intermediate transfer belt 450 is rotatably supported by a plurality of support rollers 454. One of the plurality of support rollers 454 rotates by being driven by a belt drive device (not shown). This causes the intermediate transfer belt 450 to rotate.

Each of the primary transfer devices 451 transfers the toner image formed on the surface of the photoreceptor 41 by each of the image forming units 4x to the surface of the intermediate transfer belt 450. In this way, a composite toner image obtained by combining the toner images of the four colors is formed on the surface of the intermediate transfer belt 450.

The intermediate transfer belt 450 rotates while supporting the composite toner image. The secondary transfer device 452 transfers the composite toner image formed on the surface of the intermediate transfer belt 450 to the sheet SH at the transfer position P1.

The drum cleaning device 44 removes the primary waste toner from the surface of the photoreceptor 41. The primary waste toner is a toner remaining on the surface of the photoreceptor 41, which has passed through the primary transfer device 451.

The belt cleaning device 453 removes the secondary waste toner from the surface of the intermediate transfer belt 450. The secondary waste toner is a toner remaining on the surface of the intermediate transfer belt 450, which has passed through the secondary transfer device 452.

The fixing device 5 applies pressure while heating the composite toner image on the sheet SH at the fixing position P2 (see FIG. 1) in the conveying path 300. In this way, the fixing device 5 fixes the composite toner image onto the sheet SH. The fixing position P2 is a position downstream of the transfer position P1 in a conveying direction D4 of the sheet SH (see FIG. 1). The image forming apparatus 10 forms an image on the sheet SH using the fixing device 5.

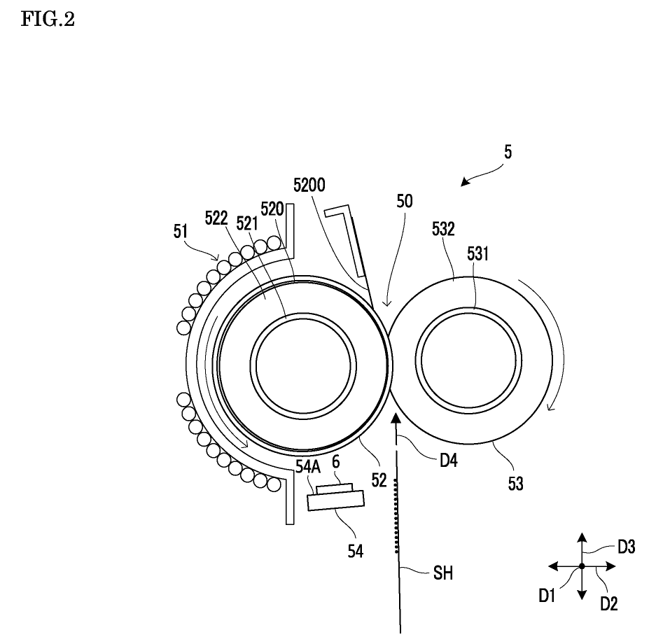

As shown in FIG. 2, the fixing device 5 includes a heater 51, a fixing belt 52, a fixing roller 520, a pressure roller 53, a sheet separation member 5200, a support surface forming portion 54, and a temperature sensor 6.

The fixing belt 52 is a flexible tubular member that encapsulates the fixing roller 520. The fixing belt 52 is heated by the heater 51. The fixing belt 52 is provided to be rotatable. The fixing belt 52 fixes the composite toner image transferred onto the sheet SH to the sheet SH. The fixing belt 52 is an example of the fixing member according to the present disclosure. Note that the fixing member according to the present disclosure may be a member formed in a roller shape.

The fixing roller 520 is a tubular member that supports the fixing belt 52 from the inside of the fixing belt 52. The fixing roller 520 includes a tubular core portion 521 and an elastic portion 522 formed on the outer periphery of the core portion 521.

The fixing roller 520 is supported to be rotatable about the rotation axis along the front-and-rear direction D1. The fixing belt 52 is rotatable about the rotation axis together with the fixing roller 520.

The fixing belt 52 includes a conductive base material, an elastic layer formed on the outer periphery of the base material, and a release layer formed on the outer periphery of the elastic layer. The base material is made of nickel. The elastic layer is made of silicon rubber. The release layer includes a PFA tube.

The heater 51 is disposed to face the outer peripheral surface of the fixing belt 52. The heater 51 is provided to face the pressure roller 53 with the fixing belt 52 sandwiched therebetween. In this embodiment, the heater 51 is an electromagnetic induction heating device. The heater 51 mainly heats the base material of the fixing belt 52 by electromagnetic induction.

The pressure roller 53 is supported to be rotatable. The pressure roller 53 also includes a tubular core portion 531 and an elastic portion 532 formed on the outer periphery of the core portion 531, similarly to the fixing roller 520. The pressure roller 53 is an example of the pressure member according to the present disclosure.

The pressure roller 53 rotates by being driven by a drive device (not shown). The fixing belt 52 and the fixing roller 520 rotate in conjunction with the pressure roller 53.

The fixing belt 52 heats the toner image formed on the sheet SH. The pressure roller 53 pressurizes the toner image toward the sheet SH.

The fixing belt 52 and the pressure roller 53 convey the sheet SH on which the toner image has been transferred and form a fixing nip portion 50 (see FIG. 2) for fixing the toner image onto the sheet SH. The fixing position P2 is a position at which the fixing nip portion 50 is formed. The fixing belt 52 and the pressure roller 53 are arranged side by side in the right-and-left direction D2 (see FIG. 1). The heater 51 heats the fixing belt 52 on the side of the fixing belt 52 opposite to the pressure roller 53.

The sheet separation member 5200 peels off the sheet SH from the fixing belt 52 when the sheet SH adheres to the fixing belt 52.

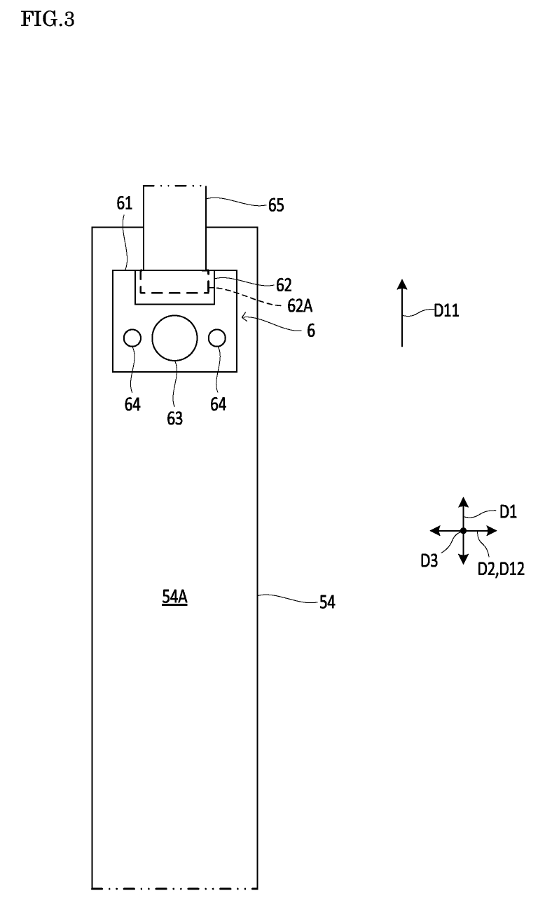

The support surface forming portion 54 is provided separately from the pressure roller 53 and the heater 51 and forms a support surface 54A (see FIG. 2) facing the fixing belt 52. For example, as shown in FIG. 3, the support surface forming portion 54 is a flat plate-shaped member long in the front-and-rear direction D1. The support surface forming portion 54 is provided downstream of the heater 51 in the rotation direction of the fixing belt 52 indicated by an arrow in FIG. 2 and upstream of the fixing nip portion 50 in this rotation direction. As shown in FIG. 2, the support surface forming portion 54 is provided below the fixing belt 52.

The temperature sensor 6 is provided on the support surface 54A. The temperature sensor 6 detects the temperature of the fixing belt 52.

As shown in FIG. 3, the temperature sensor 6 includes a substrate 61, a connector 62, a temperature detection device 63, and a pair of through hole portions 64.

The substrate 61 is formed in a rectangular shape. The connector 62 and the temperature detection device 63 are mounted on the substrate 61. Further, the pair of through hole portions 64 is formed on the substrate 61.

A cable 65 (see FIG. 3) for electrically connecting the temperature sensor 6 and a control unit (not shown) is inserted into the connector 62. The connector 62 includes a connection portion 62A (see FIG. 3) to which the cable 65 is connected.

The temperature detection device 63 detects the temperature of the fixing belt 52. The temperature detection device 63 is a thermopile. Note that the temperature detection device 63 is not limited to the thermopile and only needs to be a device capable of detecting the temperature of the fixing belt 52 in a non-contact manner.

The pair of through hole portions 64 is used for positioning the temperature sensor 6 on the support surface 54A. The support surface 54A is provided with a pair of protruding portions (not shown) that can be inserted through the through hole portions 64. The temperature sensor 6 is positioned on the support surface 54A by inserting the pair of protruding portions of the support surface 54A through the pair of through hole portions 64 of the substrate 61.

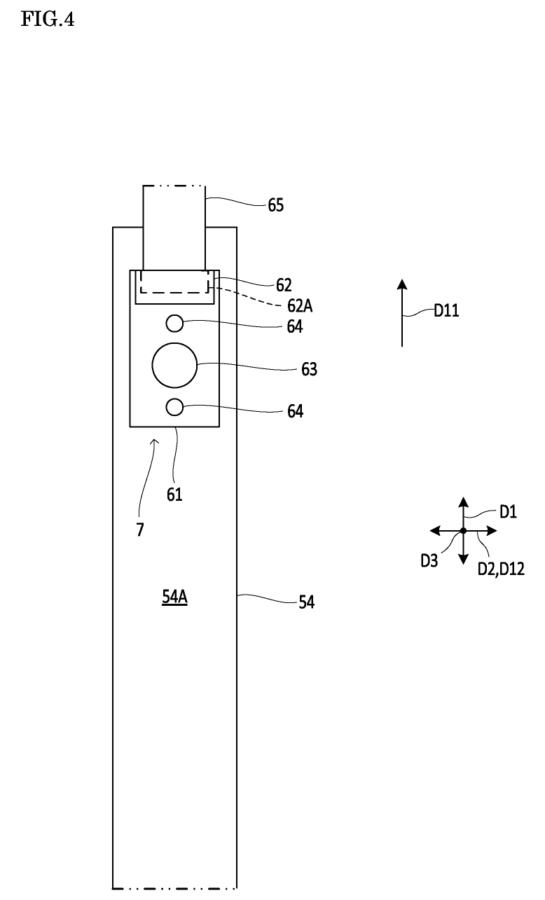

Incidentally, if the width of the support surface 54A along the outer periphery of the fixing belt 52 is large, the conveying space for the sheet SH conveyed via the fixing nip portion 50 is compressed by the support surface forming portion 54 (see FIG. 2). For this reason, it is desirable to make the width of the support surface 54A as narrow as possible. Meanwhile, a fixing device is known in the related art, including a temperature sensor 7 (see FIG. 4) in which the connector 62, the temperature detection device 63, and the pair of through hole portions 64 are arranged in a row along the longitudinal direction of the substrate 61 that is long in one direction, the temperature sensor 7 being disposed on the support surface 54A in the posture along the rotation axis of the fixing belt 52.

However, in the above-mentioned fixing device in the related art, the orientation of the connection portion 62A in the connector 62 is restricted to two directions (either direction along the front-and-rear direction D1). For this reason, the routing of the cable 65 in the fixing device is restricted.

On the other hand, the image forming apparatus 10 according to the embodiment of the present disclosure is capable of suppressing compression of the conveying space for the sheet SH and increasing the flexibility of routing of the cable 65.

Specifically, in the temperature sensor 6 of the image forming apparatus 10, the connector 62 is provided at an end of the substrate 61 on the downstream side in a first direction D11 (see FIG. 3) along one side of the substrate 61 and the connection portion 62A is disposed in a posture facing the first direction D11, as shown in FIG. 3. That is, in the case where the connection portion 62A is male, the connection portion 62A is disposed in a posture where the protruding portion that is inserted into the female connector of the cable 65 protrudes in the first direction D11. Further, in the case where the connection portion 62A is female, the connection portion 62A is disposed in a posture where the opening through which the male connector of the cable 65 is inserted opens in the first direction D11. Further, the connector 62 is disposed at the center of the substrate 61 in the right-and-left direction D2.

Further, in the temperature sensor 6 of the image forming apparatus 10, the temperature detection device 63 is provided upstream of the connector 62 on the substrate 61 in the first direction D11(see FIG. 3), as shown in FIG. 3. Specifically, the temperature detection device 63 is disposed to be adjacent to the connector 62 in the front-and-rear direction D1. Further, the temperature detection device 63 is disposed at the center of the substrate 61 in the right-and-left direction D2.

Further, in the temperature sensor 6 of the image forming apparatus 10, the pair of through hole portions 64 is provided on both sides of the temperature detection device 63 in a second direction D12 (see FIG. 3) orthogonal to the first direction D11, as shown in FIG. 3. Specifically, the pair of through hole portions 64 is disposed to face each other in the second direction D12 with the temperature detection device 63 sandwiched therebetween.

This allows the difference between the size of the substrate 61 in the longitudinal direction and the size in the lateral direction to be reduced as compared with the existing temperature sensor 7 (see FIG. 4). For this reason, it is possible to reduce the necessary size of the width of the support surface 54A in the case where the temperature sensor 6 is disposed in a posture where the longitudinal direction of the substrate 61 is orthogonal to the rotation axis of the fixing belt 52 in order to orient the connection portion 62A in either the right or left direction. That is, the image forming apparatus 10 is capable of suppressing compression of the conveying space for the sheet SH and increasing the flexibility of routing of the cable 65, as compared with an image forming apparatus including the existing temperature sensor 7.

### Other embodiments

Note that the image forming apparatus 10 may include a plurality of temperature sensors 6.

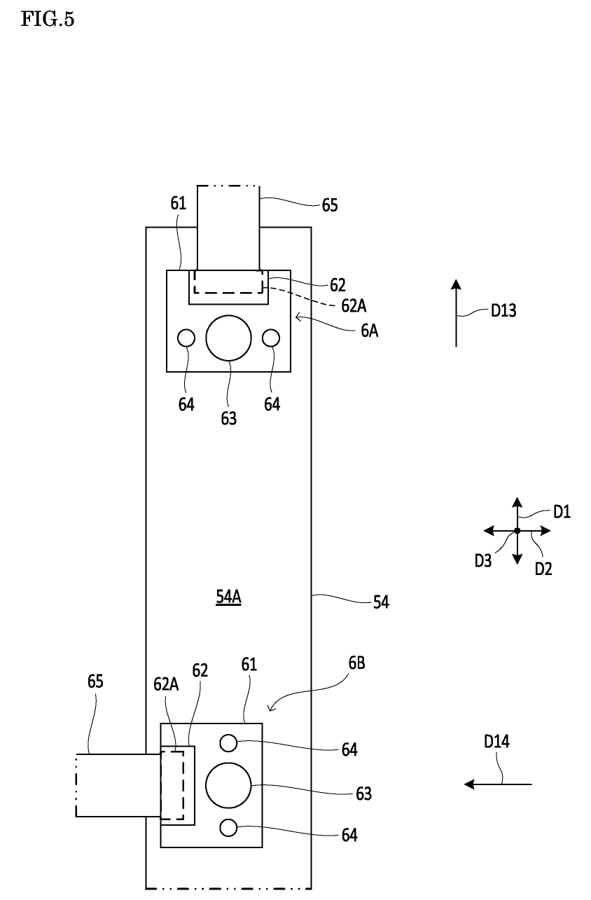

For example, the image forming apparatus 10 may include a first temperature sensor 6A and a second temperature sensor 6B shown in FIG. 5.

The first temperature sensor 6A is the temperature sensor 6 disposed in a posture where the connection portion 62A of the connector 62 faces a third direction D13 (see FIG. 5) along the rotation axis of the fixing belt 52.

Further, the second temperature sensor 6B is the temperature sensor 6 disposed in a posture where the connection portion 62A of the connector 62 faces a fourth direction D14 (see FIG. 5) orthogonal to the third direction D13.

The image forming apparatus 10 including the first temperature sensor 6A and the second temperature sensor 6B is capable of suppressing compression of the conveying space for the sheet SH as compared with a configuration including a plurality of existing temperature sensors 7 (see FIG. 4) with different postures.

### Notes of disclosure

The outline of the disclosure extracted from the above-mentioned embodiments will be given below. Note that the configurations and processing functions described in the following notes can be arbitrarily selected and combined.

### Note 1

A fixing device, including:

a fixing member that is mounted to be rotatable and fixes a toner image transferred onto a sheet to the sheet;

a pressure member that forms a fixing nip portion between the pressure member and the fixing member;

a heater that is provided to face the pressure member with the fixing member sandwiched therebetween and heats the fixing member;

a support surface forming portion that is provided separately from the pressure member and the heater and forms a support surface facing the fixing member; and

a temperature sensor that is provided on the support surface and detects a temperature of the fixing member,

the temperature sensor including

a rectangular substrate,

a connector that is provided at an end of the substrate on a downstream side in a first direction along one side of the substrate and has a connection portion to which a cable is connected that faces the first direction,

a temperature detection device that is provided upstream of the connector on the substrate in the first direction and detects the temperature of the fixing member, and

a pair of through hole portions that is provided on both sides of the temperature detection device in a second direction orthogonal to the first direction and used for positioning the temperature sensor on the support surface.

### Note 2

The fixing device according to Note 1, in which

the temperature sensor includes a plurality of temperature sensors,

a first temperature sensor of the plurality of temperature sensors is disposed in a posture where the connection portion of the connector faces a third direction along a rotation axis of the fixing member, and

a second temperature sensor of the plurality of temperature sensors is disposed in a posture where the connection portion of the connector faces a fourth direction orthogonal to the third direction.

### Note 3

An image forming apparatus, including:

the fixing device according to Note 1 or 2,

the fixing device being used to form an image on the sheet.

### Note 4

A temperature sensor that is provided on a support surface in a fixing device that includes a fixing member that is mounted to be rotatable and fixes a toner image transferred onto a sheet to the sheet, a pressure member that forms a fixing nip portion between the pressure member and the fixing member, a heater that is provided to face the pressure member with the fixing member sandwiched therebetween and heats the fixing member, and a support surface forming portion that is provided separately from the pressure member and the heater and forms the support surface facing the fixing member, and detects a temperature of the fixing member, including:

a rectangular substrate;

a connector that is provided at an end of the substrate on a downstream side in a first direction along one side of the substrate and has a connection portion to which a cable is connected that faces the first direction;

a temperature detection device that is provided upstream of the connector on the substrate in the first direction and detects the temperature of the fixing member; and

a pair of through hole portions that is provided on both sides of the temperature detection device in a second direction orthogonal to the first direction and used for positioning the temperature sensor on the support surface.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A fixing device, comprising:
a fixing member that is mounted to be rotatable and fixes a toner image transferred onto a sheet to the sheet;
a pressure member that forms a fixing nip portion between the pressure member and the fixing member;
a heater that is provided to face the pressure member with the fixing member sandwiched therebetween and heats the fixing member;
a support surface forming portion that is provided separately from the pressure member and the heater and forms a support surface facing the fixing member; and
one or more temperature sensors that is provided on the support surface and detects a temperature of the fixing member,
the temperature sensor including
a rectangular substrate,
a connector that is provided at an end of the substrate on a downstream side in a first direction along one side of the substrate and has a connection portion to which a cable is connected that faces the first direction,
a temperature detection device that is provided upstream of the connector on the substrate in the first direction and detects the temperature of the fixing member, and
a pair of through hole portions that is provided on both sides of the temperature detection device in a second direction orthogonal to the first direction and used for positioning the temperature sensor on the support surface.

2. The fixing device according to claim 1, wherein
a plurality of the temperature sensors,
a first temperature sensor of the plurality of temperature sensors is disposed in a posture where the connection portion of the connector faces a third direction along a rotation axis of the fixing member, and
a second temperature sensor of the plurality of temperature sensors is disposed in a posture where the connection portion of the connector faces a fourth direction orthogonal to the third direction.

3. An image forming apparatus, comprising:
the fixing device according to claim 1,
the fixing device being used to form an image on the sheet.

4. A temperature sensor that is provided on a support surface in a fixing device that includes a fixing member that is mounted to be rotatable and fixes a toner image transferred onto a sheet to the sheet, a pressure member that forms a fixing nip portion between the pressure member and the fixing member, a heater that is provided to face the pressure member with the fixing member sandwiched therebetween and heats the fixing member, and a support surface forming portion that is provided separately from the pressure member and the heater and forms the support surface facing the fixing member, and detects a temperature of the fixing member, comprising:
a rectangular substrate;
a connector that is provided at an end of the substrate on a downstream side in a first direction along one side of the substrate and has a connection portion to which a cable is connected that faces the first direction;
a temperature detection device that is provided upstream of the connector on the substrate in the first direction and detects the temperature of the fixing member; and
a pair of through hole portions that is provided on both sides of the temperature detection device in a second direction orthogonal to the first direction and used for positioning the temperature sensor on the support surface.
